(19) United States
(12) Patent Application Publication
(10) Pub. No.: US 2023/0228384 A1
(43) Pub. Date: Jul. 20, 2023

(54) DETECTION DEVICE AND DETECTION METHOD

(71) Applicant: NIPPON TELEGRAPH AND TELEPHONE CORPORATION, Tokyo (JP)

(72) Inventors: Masaru OKUTSU, Tokyo (JP); Akira ITO, Tokyo (JP)

(73) Assignee: NIPPON TELEGRAPH AND TELEPHONE CORPORATION, Tokyo (JP)

(21) Appl. No.: 17/928,898

(22) PCT Filed: Jun. 3, 2020
(86) PCT No.: PCT/JP2020/021937

§ 371 Date: Nov. 30, 2022

(51) Int. Cl. F17D 5/06; G01N 29/12; G01N 29/04

(52) U.S. Cl. CPC F17D 5/06; G01N 29/12; G01N 29/048

(57) ABSTRACT

A detection device (100) for detecting damage to a conduit (300) buried in ground includes: a sensor (10) for detecting breaking sound at the time of conduit damage; a processing unit (20) for determining a relation of magnitude between a characteristic value of the breaking sound and a threshold; and an indication unit (30) for indicating that the conduit is damaged when the relation of magnitude satisfies a predetermined condition.

### TECHNICAL FIELD

The present invention relates to detection devices and detection methods.

### BACKGROUND ART

A method where an operator enters a manhole and inspects a conduit using a pipe camera is known, since it is extremely difficult for an operator to visually determine whether a conduit buried in ground has been damaged by an earthquake and the like or not from above ground. Also known are methods of detecting any leaking sound of or measuring a flow speed of fluid flowing in a conduit from above ground in inspection of an underground conduit such as for water or gas (see Patent Literature 1, for instance), and a method of emitting an electromagnetic wave and analyzing a reflected wave (see Patent Literature 2, for instance).

From analysis of the status of conduit damages caused by past large earthquakes, it is known that damaged portions of conduits are often found in couplings that have no displacement absorbing feature. It is also known that large breaking sound occurs when a coupling breaks from a laboratory experiment of measuring the load carrying capacity of couplings. FIG. 13A shows an example of an experiment system for a tensile fracture experiment on a steel-pipe threaded coupling in a laboratory experiment to measure the load carrying capacity of couplings. A steel-pipe threaded coupling breaks under a tensile load of about 200 kN. Forms of breakage include detachment while crushing threads and rupture at a thread portion. FIG. 13B shows an example of breaking sound of a steel-pipe threaded coupling which was recorded in video capturing such a tensile fracture experiment. It can be seen that large breaking sound occurs when a steel-pipe threaded coupling breaks.

### CITATION LIST

### Patent Literature

Patent Literature 1: Japanese Patent Laid-Open No. 1992-32735
Patent Literature 2: Japanese Patent Laid-Open No. 2015-121409

### SUMMARY OF THE INVENTION

### Technical Problem

As a method of determining whether a conduit buried in ground has been damaged or not, an inspection method using a pipe camera has the following issues:

(1) Requiring large-scaled equipment and staff to operate it, and also occupying part of a road as a working space for a long time, thus affecting traffic;

(2) If earth and sand has flowed inside a conduit to block it, the conduit cannot be inspected beyond that point.

(3) If a cable is accommodated inside a conduit, inspection cannot be performed because there is no space to insert a pipe camera.

The method of detecting a leaking sound of fluid has the problems of being significantly affected by noise from a surrounding environment and no leaking sound occurring in the case of a conduit that accommodates a cable, instead of fluid, in it. A method using electromagnetic wave and the like is effective for metallic pipes but has problems in terms of application to resin conduits and limitation associated with the depth of burying of a conduit.

The present invention has been made in view of these circumstances and has an object of providing detection devices and detection methods that enable easy detection of damage due to an earthquake and the like even on a conduit buried in ground for which visual inspection is difficult.

### Means for Solving the Problem

A detection device according to an embodiment is a detection device for detecting damage to a conduit buried in ground, including: a sensor for detecting breaking sound at time of conduit damage; a processing unit for determining a relation of magnitude between a characteristic value of the breaking sound and a threshold; and an indication unit for indicating that the conduit is damaged when the relation of magnitude satisfies a predetermined condition.

A detection method according to an embodiment is a detection method for detecting damage to a conduit buried in ground, including the steps of: detecting breaking sound at time of conduit damage; determining a relation of magnitude between a characteristic value of the breaking sound and a threshold; and indicating that the conduit is damaged when the relation of magnitude satisfies a predetermined condition.

### Effects of the Invention

The present invention can provide detection devices and detection methods that enable easy detection of damage due to an earthquake and the like even on a conduit buried in ground for which visual inspection is difficult.

### BRIEF DESCRIPTION OF DRAWINGS

FIG. 1 shows an exemplary application of a detection device according to a first embodiment.

FIG. 2 shows an example of configuration of the detection device according to the first embodiment.

FIG. 3 shows an example of an installation portion of a conduit according to the first embodiment.

FIG. 4 shows examples of an indication unit on the detection device according to the first embodiment.

FIG. 5 is a flowchart showing an example of a detection method according to the first embodiment.

FIG. 6 shows an example of configuration of the detection device according to a second embodiment.

FIG. 7A shows an example of a notification unit in the detection device according to the second embodiment.

FIG. 7B shows an example of a notification unit in the detection device according to the second embodiment.

FIG. 8 is a flowchart showing an example of a detection method according to the second embodiment.

FIG. 9 shows an example of configuration of the detection device according to a third embodiment.

FIG. 10 shows an example of an actuation unit and an optical time domain reflectometer in the detection device according to a third embodiment.

FIG. 11 is a flowchart showing an example of a detection method according to the third embodiment.

FIG. 12 shows an example of configuration of the detection device according to a variation.

FIG. 13A shows an example of an experiment system for a tensile fracture experiment on a steel-pipe threaded coupling.

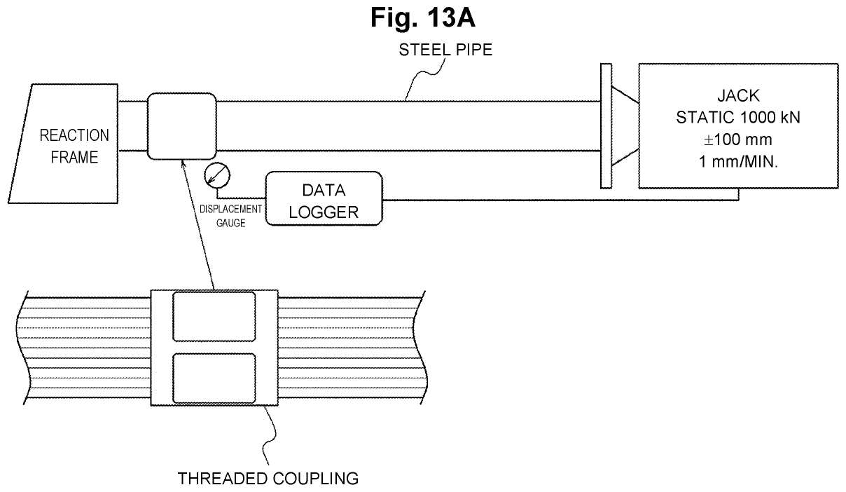

FIG. 13B shows an example of breaking sound of a steel-pipe threaded coupling.

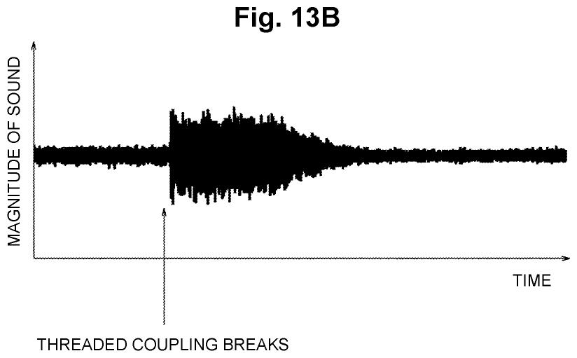

### DESCRIPTION OF EMBODIMENTS

An embodiment of the present invention is now described in detail with reference to the drawings.

### First Embodiment

### <Detection Device>

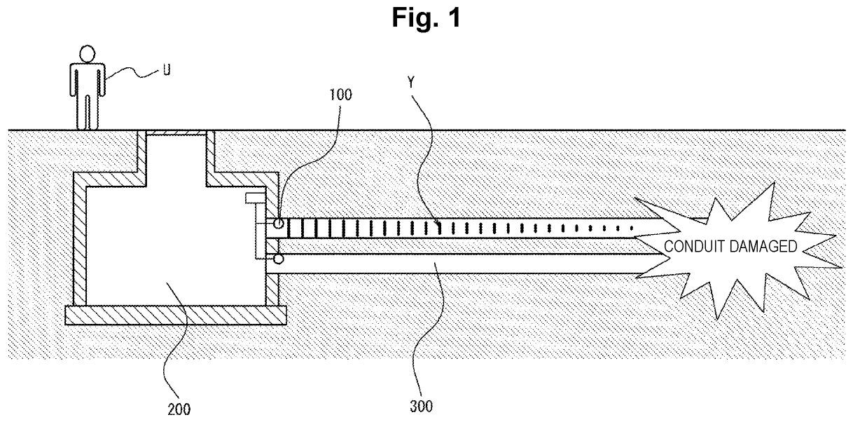

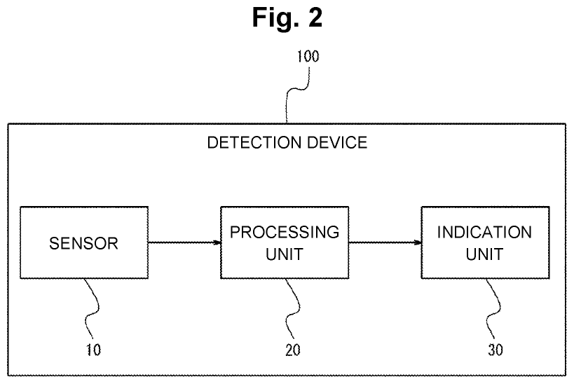

Referring to FIGS. 1 to 4, an example configuration of a detection device 100 according to a first embodiment will be described.

The detection device 100 is a device to detect any damage to a conduit 300 buried in ground. The detection device 100 includes a sensor 10, a processing unit 20 and an indication unit 30.

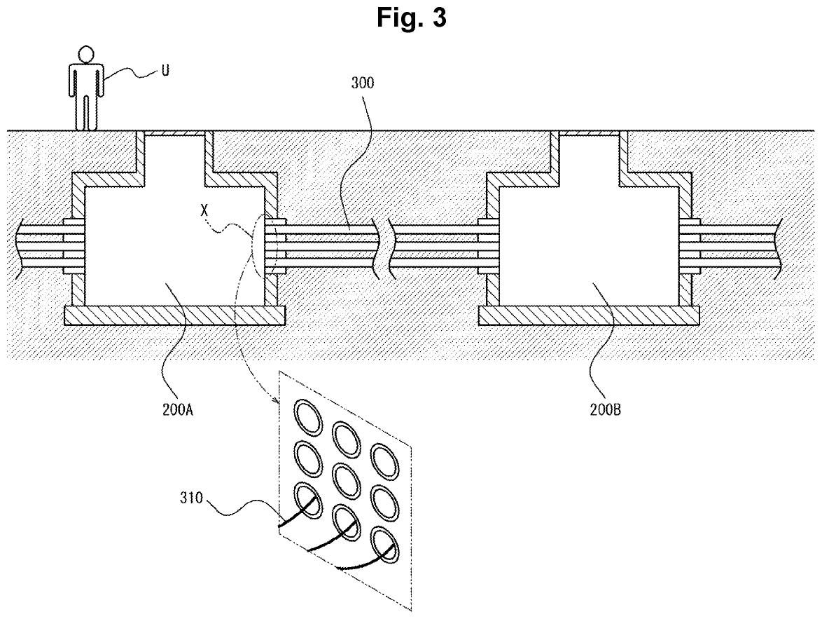

As shown in FIG. 3, the conduit 300 accommodates and protects a cable 310 or the like, and connects between a manhole 200A and a manhole 200B. The manholes 200A, 200B are provided for connection and branching of the cable 310 and have a working space in their insides, which an operator U can enter. The detection device 100 is disposed in a conduit installation portion X in the manhole 200 at which the conduit 300 is installed.

The sensor 10 detects a breaking sound Y at the time of conduit damage. The sensor 10 converts the detected breaking sound Y into an electrical signal and outputs it to the processing unit 20. The sensor 10 may be a microphone, for example. There is no specific limitation in the microphone; it may be a monaural microphone, a stereo microphone or a wireless microphone, for example.

Preferably, there are a number of sensors 10 and they are preferably provided such that each corresponds to one conduit 300 in the conduit installation portion X. This enables the sensor 10 to accurately detect the breaking sound Y at the time of conduit damage.

The processing unit 20 applies signal processing to an electrical signal input from the sensor 10 and analyzes sound pressure, signal strength, frequency, time and the like. The processing unit 20 determines a relation of magnitude between a characteristic value of the breaking sound at the time of conduit damage and a predetermined threshold based on the results of analysis. When the relation of magnitude between the characteristic value of the breaking sound at the time of conduit damage and the predetermined threshold satisfies a predetermined condition (e.g., a condition that the magnitude of the breaking sound at the time of conduit damage is larger than the threshold), the processing unit 20 outputs a determination result to the effect that the conduit 300 is damaged to the indication unit 30. When it determines that the relation of magnitude between the characteristic value of the breaking sound at the time of conduit damage and the predetermined threshold does not satisfy the predetermined condition, the processing unit 20 outputs a determination result to the effect that the conduit 300 is not damaged to the indication unit 30. There is no specific limitation in the predetermined threshold; it is set by the processing unit 20 as appropriate.

The indication unit 30 provides a certain indication based on a determination result input from the processing unit 20. The indication unit 30 may be a paint ejection device, a lamp or the like, for example. For example, the indication unit 30 indicates that the conduit 300 is damaged based on a determination result to the effect that the conduit 300 is damaged. For example, the indication unit 30 indicates that the conduit 300 is not damaged based on a determination result to the effect that the conduit 300 is not damaged. There is no specific limitation in the way of indication by the indication unit 30.

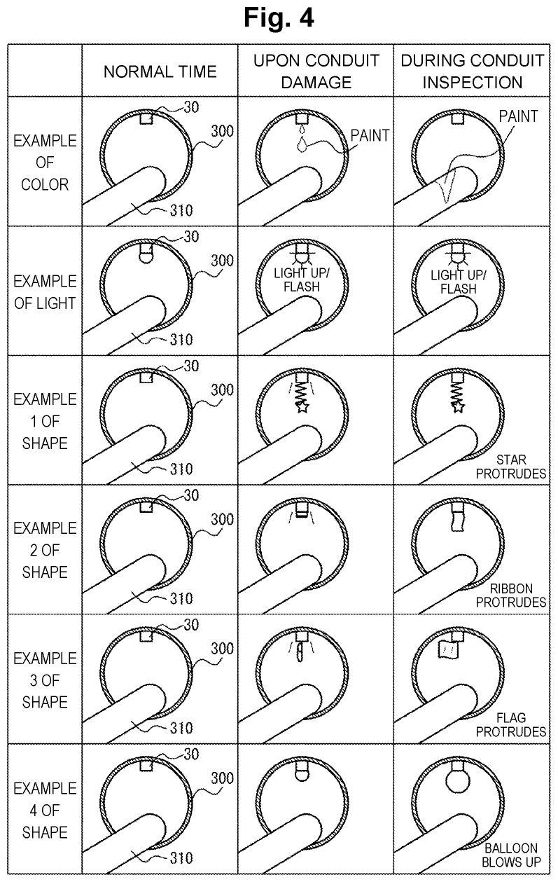

As shown in the “Example of color” in FIG. 4, the indication unit 30 indicates that the conduit 300 is damaged or the conduit 300 is not damaged by means of color, for example. At normal times, the indication unit 30 indicates that the conduit 300 is not damaged by not ejecting paint of a predetermined color. In the event of conduit damage, the indication unit 30 indicates that the conduit 300 is damaged by ejecting paint of the predetermined color. When inspecting the conduit, the operator U visually checks the indication unit 30 or around the indication unit 30; the operator can determine that the conduit 300 is damaged if paint is attached to the cable 310, and can determine that the conduit 300 is not damaged if no paint is attached to the cable 310.

As shown in the “Example of light” in FIG. 4, the indication unit 30 indicates that the conduit 300 is damaged or the conduit 300 is not damaged by means of light, for example. At normal times, the indication unit 30 indicates that the conduit 300 is not damaged by turning off. In the event of conduit damage, the indication unit 30 indicates that the conduit 300 is damaged by lighting up or flashing. When inspecting the conduit, the operator U visually checks the indication unit 30; the operator can determine that the conduit 300 is damaged if the indication unit 30 is lighting up or flashing, and can determine that the conduit 300 is not damaged if the indication unit 30 is off.

As shown in the “Examples 1 to 4 of shapes” in FIG. 4, the indication unit 30 indicates that the conduit 300 is damaged or the conduit 300 is not damaged by means of shapes, for example. At normal times, the indication unit 30 indicates that the conduit 300 is not damaged by not indicating a certain shape. In the event of conduit damage, the indication unit 30 indicates that the conduit 300 is damaged by indicating a star, a ribbon, a flag and the like or blowing up a balloon. When inspecting the conduit, the operator U visually checks the indication unit 30 or around the indication unit 30; the operator can determine that the conduit 300 is damaged if a star, a ribbon, a flag and the like is projecting or a balloon has been blown up, and can determine that the conduit 300 is not damaged if the indication unit 30 is indicating nothing.

The detection device 100 according to this embodiment includes the sensor 10 for detecting breaking sound at the time of conduit damage, the processing unit 20 for determining a relation of magnitude between a characteristic value of the breaking sound and a threshold, and the indication unit 30 for indicating that the conduit is damaged when the relation of magnitude satisfies a predetermined condition. This enables damage due to an earthquake and the like to be easily detected even on a conduit buried in ground for which visual inspection is difficult.

Further, efficient determination of detailed damage status and damaged sites becomes possible because applying the detection device 100 according to this embodiment by the operator U allows an inspection with a pipe camera to be conducted only on conduits for which damage has been detected. It also enables efficient employment of limited staff and equipment. Furthermore, works on roads can be minimized to reduce influence on traffic in an affected area.

<Detection Method>

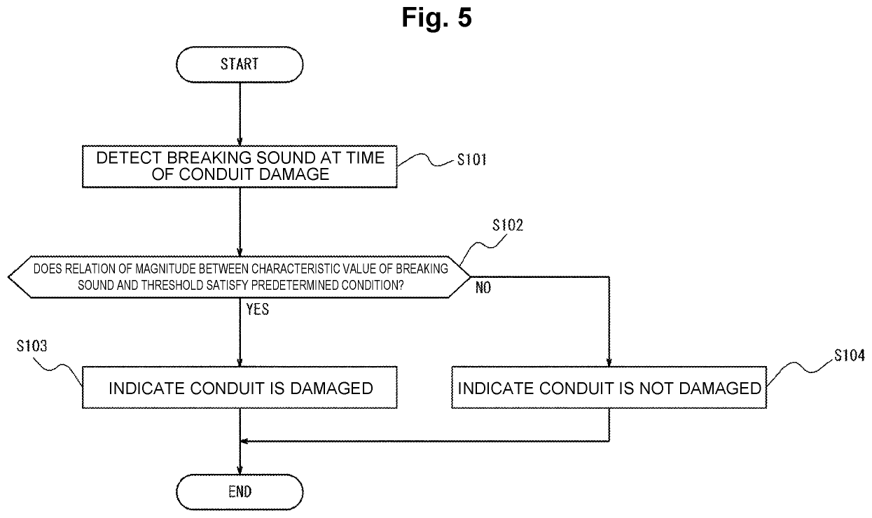

Now referring to FIG. 5, a detection method according to the first embodiment is described.

At step S101, the detection device 100 detects breaking sound at the time of conduit damage.

At step S102, the detection device 100 determines the relation of magnitude between a characteristic value of the breaking sound and a threshold. If the relation of magnitude between the characteristic value of the breaking sound and the threshold satisfies a predetermined condition, the detection device 100 performs the processing of step S103. If the relation of magnitude between the characteristic value of the breaking sound and the threshold does not satisfy the predetermined condition, the detection device 100 performs the processing of step S104.

At step S103, the detection device 100 indicates that the conduit 300 is damaged.

At step S104, the detection device 100 indicates that the conduit 300 is not damaged.

With the detection method described above, damage due to an earthquake and the like can be easily detected even on a conduit buried in ground for which visual inspection is difficult.

### Second Embodiment

### <Detection System>

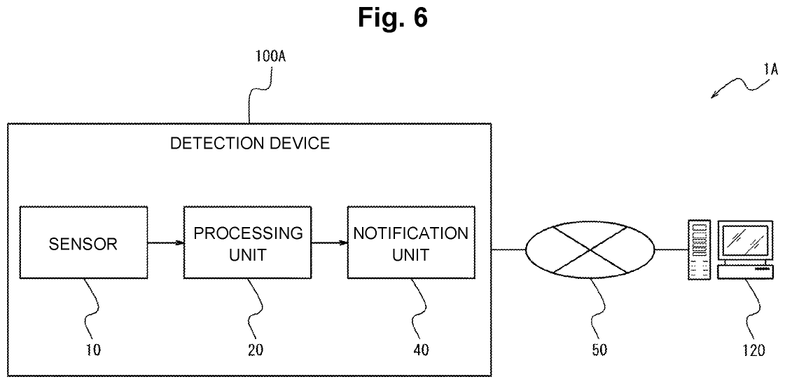

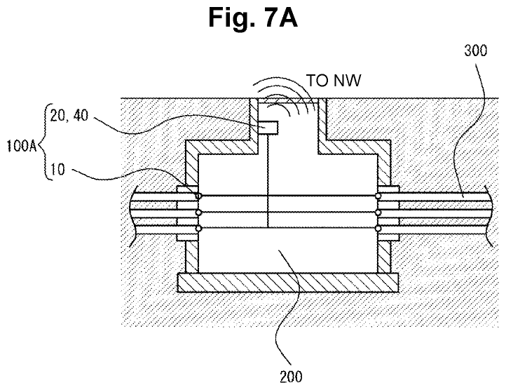

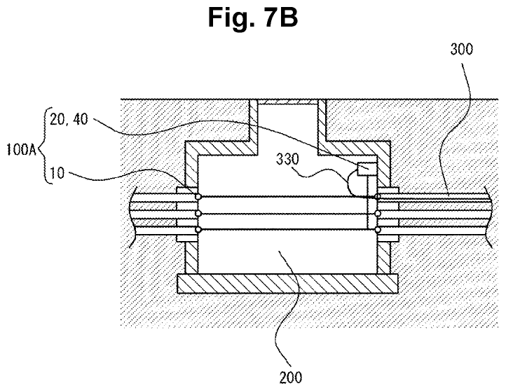

Referring to FIGS. 6, 7A and 7B, an example configuration of a detection system 1A according to a second embodiment is described.

The detection system 1A includes a detection device 100A and a monitoring device 120. The detection device 110 and the monitoring device 120 are connected so that they can communicate over a network 50 by wire or wirelessly. There is no specific limitation in the way of communication for transmission and reception of information between the devices.

A difference of the detection device 100A according to the second embodiment from the detection device 100 according to the first embodiment is that the detection device 100A according to the second embodiment includes a notification unit 40, as opposed to the indication unit 30 of the detection device 100 according to the first embodiment. As the configuration is otherwise the same as that of the detection device 100 according to the first embodiment, overlapping description is not provided.

The notification unit 40 provides a predetermined notification based on a determination result input from the processing unit 20. For example, the notification unit 40 notifies the monitoring device 120 that the conduit 300 is damaged based on a determination result to the effect that the conduit 300 is damaged. For example, the notification unit 40 notifies the monitoring device 120 that the conduit 300 is not damaged based on a determination result to the effect that the conduit 300 is not damaged. There is no specific limitation in the way of notification by the notification unit 40.

As shown in FIG. 7A, the notification unit 40 may be wirelessly connected with the monitoring device 120 over the network 50 and transmit information that the conduit 300 is damaged or information that the conduit 300 is not damaged to the monitoring device 120, for example.

As shown in FIG. 7B, the notification unit 40 may be connected with the monitoring device 120 over the network 50 by wire such as a connection cable 330, and transmit information that the conduit 300 is damaged or information that the conduit 300 is not damaged to the monitoring device 120, for example.

The notification unit 40 also transmits information indicating a symbol or a number (ID) identifying the individual sensor 10 to the monitoring device 120 in addition to information that the conduit 300 is damaged or information that the conduit 300 is not damaged. This allows the monitoring device 120 to positively identify damaged and undamaged conduits and monitor each conduit 300 appropriately.

The monitoring device 120 monitors installations such as the manhole 200, the conduit 300 and the cable 310. For example, the monitoring device 120 monitors whether the conduit 300 has been damaged or not based on information received from the detection device 100A. The monitoring device 120 may be a mobile phone such as a smartphone, a tablet terminal, a notebook PC (personal computer) being used by the operator U, for example. The operator U visually checks a certain screen displayed on a display unit of the monitoring device 120; the operator can determine that the conduit 300 is damaged if information that the conduit 300 is damaged is being displayed, and can determine that the conduit 300 is not damaged if information that the conduit 300 is not damaged is being displayed.

The detection device 100A according to the second embodiment enables easy detection of damage due to an earthquake and the like even on a conduit buried in ground for which visual inspection is difficult.

<Detection Method>

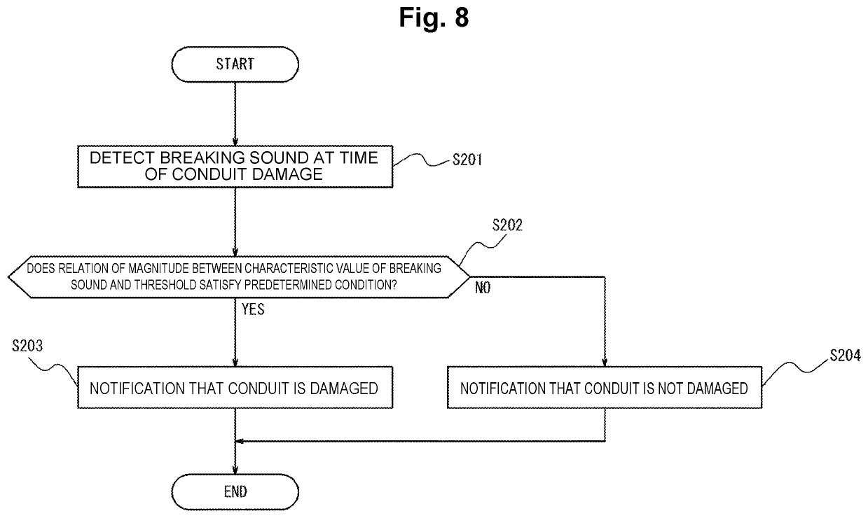

Now referring to FIG. 8, the detection method according to the second embodiment is described.

At step S201, the detection device 100A detects breaking sound at the time of conduit damage.

At step S202, the detection device 100A determines the relation of magnitude between a characteristic value of the breaking sound and a threshold. If the relation of magnitude between the characteristic value of the breaking sound and the threshold satisfies a predetermined condition, the detection device 100A performs the processing of step S203. If the relation of magnitude between the characteristic value of the breaking sound and the threshold does not satisfy the predetermined condition, the detection device 100A performs the processing of step S204.

At step S203, the detection device 100A provides a notification that the conduit 300 is damaged.

At step S204, the detection device 100A provides a notification that the conduit 300 is not damaged.

With the detection method described above, damage due to an earthquake and the like can be easily detected even on a conduit buried in ground for which visual inspection is difficult.

### Third Embodiment

### <Detection System>

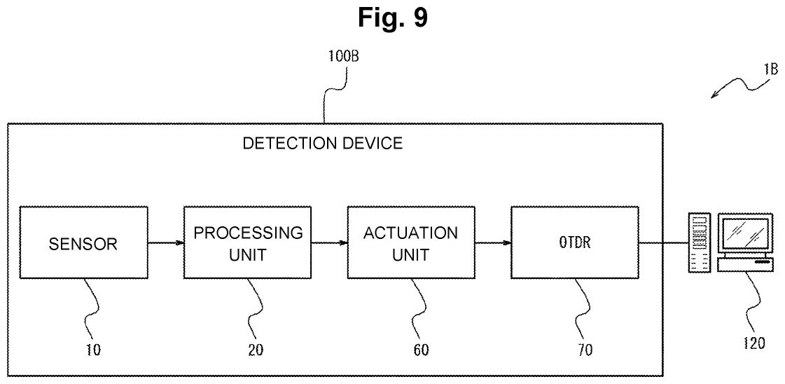

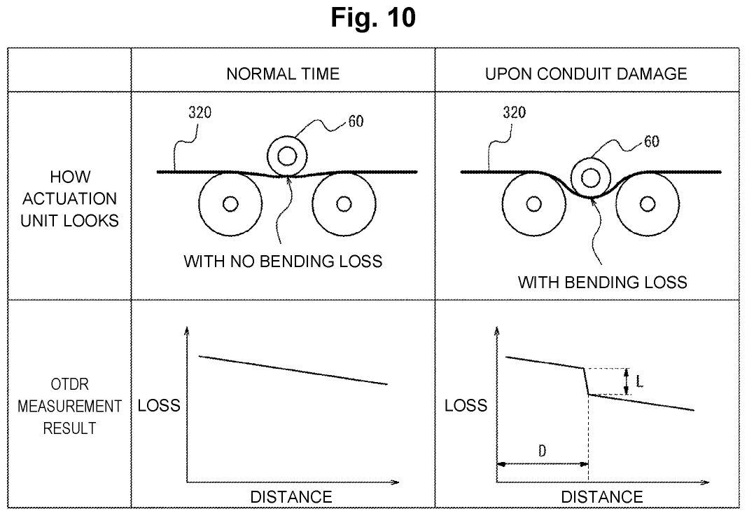

Referring to FIGS. 9 and 10, an example configuration of a detection system 1B according to a third embodiment is described.

A difference of the detection system 1B according to the third embodiment from the detection system 1A according to the second embodiment is that the detection system 1B according to the third embodiment includes an actuation unit 60 and an optical time domain reflectometer (OTDR) 70 as the notification unit, as opposed to the notification unit 40 of the detection system 1A according to the second embodiment. As the configuration is otherwise the same as that of the detection system 1A according to the second embodiment, overlapping description is not provided.

The actuation unit 60 is activated or not activated based on a determination result input from the processing unit 20. For example, as shown in FIG. 10, the actuation unit 60 is activated and produces bending loss in an optical fiber 320 when it has received a determination result that the conduit 300 is damaged from the processing unit 20. For example, as shown in FIG. 10, the actuation unit 60 is not activated and does not produce bending loss in the optical fiber 320 when it has received a determination result that the conduit 300 is not damaged from the processing unit 20. The actuation unit 60 shown in FIG. 10 illustrates an approach in which a center pulley of three pulleys arranged side by side moves downward, as an example of a method of producing bend in optical fiber. Methods like holding the optical fiber at two points and producing relative displacement in a direction perpendicular to the optical fiber axis or producing a bend in optical fiber by expanding material are also possible.

The actuation unit 60 is attached to a free line of the cable 310 housed in and protected by the conduit 300, that is, an optical fiber core wire for maintenance separate from optical fiber core wires for communication. By providing the actuation unit 60 by making use of a free line of the cable 310, any damage to the conduit 300 can be detected in the detection system 1B without affecting services to customers.

The OTDR 70 measures a bending loss L in the optical fiber 320 and a distance D to a point of occurrence of the bending loss in the optical fiber 320, and transmits the measurement results to the monitoring device 120. The measurement results are represented by a graph showing the relationship between distance and loss, for example, as shown in FIG. 10.

For example, when a bending loss is given to the optical fiber by the actuation unit 60, the OTDR 70 transmits information including the fact that a bending loss is occurring in the optical fiber 320, the bending loss L in the optical fiber 320 and the distance D to the point of occurrence of the bending loss in the optical fiber 320 to the monitoring device 120 as information indicating that the conduit is damaged. For example, when no bending loss is being given to the optical fiber by the actuation unit 60, the OTDR 70 transmits information including the fact that no bending loss is occurring in the optical fiber 320 to the monitoring device 120 as information indicating that the conduit is not damaged. By periodically receiving measurement results from the OTDR 70, the monitoring device 120 can efficiently and accurately monitor whether the conduit 300 has been damaged or not.

For details about the OTDR 70, reference may be made to the literature below, for example:

NTT Access Network Service System Laboratories, “Optical channel testing system using a fiber selector for small buildings”, ANSL R&D Times, Vol. 58, 2009, [online], [searched on May 27, 2020], the internet <https://www.ansl.ntt.co.jp/j/times/058/01/01.html>

A detection device 100B according to the third embodiment enables easy detection of damage due to an earthquake and the like even on a conduit buried in ground for which visual inspection is difficult. The detection device 100B according to the third embodiment is also able to detect damage due to an earthquake and the like without affecting services to customers by performing transmission utilizing a free line of the cable 310.

<Detection Method>

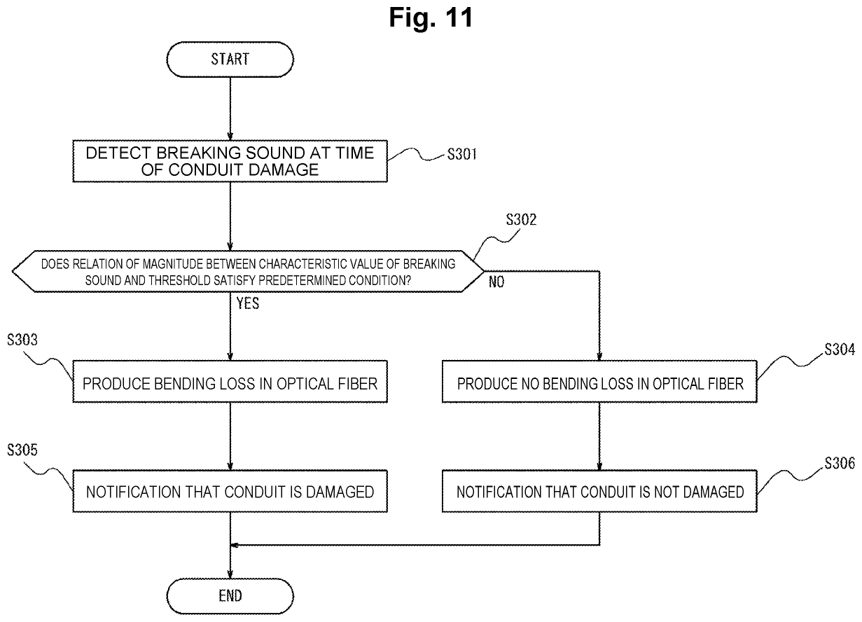

Now referring to FIG. 11, a detection method according to the third embodiment is described.

At step S301, the detection device 100B detects breaking sound at the time of conduit damage.

At step S302, the detection device 100B determines the relation of magnitude between a characteristic value of the breaking sound and a threshold. When the relation of magnitude between the characteristic value of the breaking sound and the threshold satisfies a predetermined condition, the detection device 100B performs the processing of step S303. If the relation of magnitude between the characteristic value of the breaking sound and the threshold does not satisfy the predetermined condition, the detection device 100B performs the processing of step S304.

At step S303, the detection device 100B produces bending loss in the optical fiber 320.

At step S304, the detection device 100B does not produce bending loss in the optical fiber 320.

At step S305, the detection device 100B provides a notification that the conduit 300 is damaged.

At step S306, the detection device 100B provides a notification that the conduit 300 is not damaged.

With the detection method described above, damage due to an earthquake and the like can be easily detected even on a conduit buried in ground for which visual inspection is difficult.

<Variation>

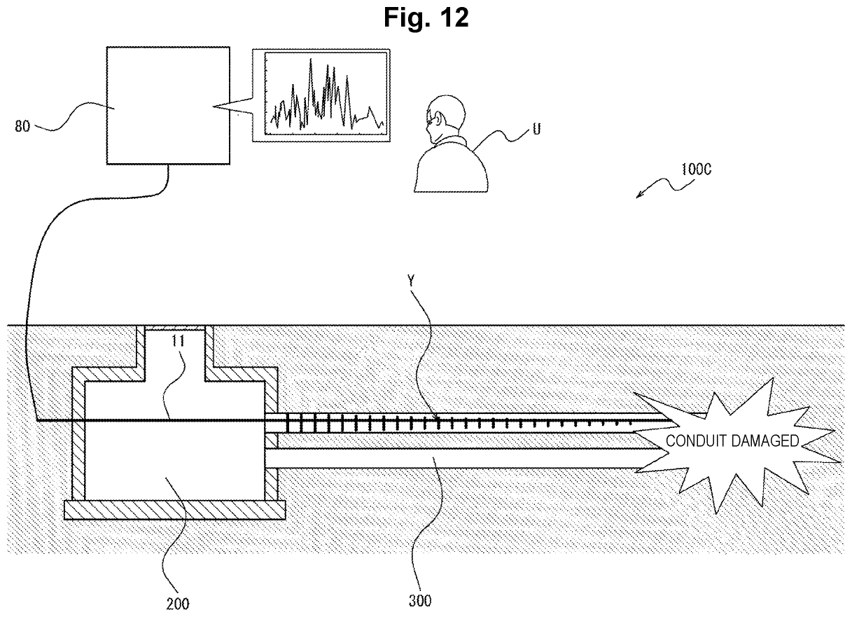

Now referring to FIG. 12, an example configuration of a detection device 100C according to a variation is described.

A difference of the detection device 100C according to the variation from the detection device 100 according to the first embodiment is that the detection device 100C according to the variation applies a portion of an optical fiber core wire as a sensor 11, as opposed to the application of a microphone as the sensor 10 in the detection device 100 according to the first embodiment. As the configuration is otherwise the same as that of the detection device 100 according to the first embodiment, overlapping description is not provided.

The detection device 100C includes the sensor 11 and a monitoring device 80. The sensor 11 and the monitoring device 80 are connected to each other via a connection cable, for example.

The sensor 11 detects breaking sound Y at the time of conduit damage. The sensor 11 converts vibration of the detected breaking sound Y into an electrical signal and outputs it to the monitoring device 80. The sensor 11 may be a portion of an optical fiber core wire, for example.

For details on vibration detection in optical fiber, reference may be made to the literature below, for example:

Japanese Patent Laid-Open No. 2019-20143

The monitoring device 80 is directly connected with the sensor 11 via a connection cable, for example. The monitoring device 80 applies signal processing to the electrical signal input from the sensor 11 and analyzes signal strength, frequency, time and the like. The monitoring device 80 determines a relation of magnitude between a characteristic value of the breaking sound at the time of conduit damage and a predetermined threshold based on the results of analysis. The monitoring device 80 also monitors whether the conduit 300 has been damaged or not based on the results of analysis and the determination result.

For example, when it determines that the relation of magnitude between the characteristic value of the breaking sound at the time of conduit damage and the predetermined threshold satisfies a predetermined condition, the monitoring device 80 indicates a determination result to the effect that the conduit 300 is damaged on its display unit. For example, when it determines that the relation of magnitude between the characteristic value of the detected sound and the predetermined threshold does not satisfy the predetermined condition, the monitoring device 80 indicates a determination result to the effect that the conduit 300 is not damaged on its display unit. The operator U visually checks a certain screen displayed on the display unit of the monitoring device 120; the operator can determine that the conduit 300 is damaged if information that the conduit 300 is damaged is being displayed, and can determine that the conduit 300 is not damaged if information that the conduit 300 is not damaged is being displayed.

The detection device 100C according to the variation enables easy detection of damage due to an earthquake and the like even on a conduit buried in ground for which visual inspection is difficult.

While the foregoing embodiments have been described as representative examples, it will be apparent to those skilled in the art that many modifications and replacements may be made within the spirit and scope of the present disclosure. Therefore, the present invention should not be construed as being limited by the foregoing embodiments but various variations and modifications are possible without departing from the scope of the claims. For example, the various processing operations described above may be carried out in parallel or individually according to the processing ability of the device to execute the processing or any need, aside from being executed chronologically in accordance with the description.

### REFERENCE SIGNS LIST

10 sensor
20 processing unit
30 indication unit
40 notification unit
50 network
60 actuation unit
70 OTDR
80 monitoring device
100, 100A, 100B, 100C detection device
120 monitoring device
200, 200A, 200B manhole
300 conduit
330 connection cable

1. A device for detecting damage to a conduit buried in ground, the device comprising a processor configured to execute a method comprising:
detecting a breaking sound at time of a conduit damage;
determining a relation of magnitude between a characteristic value of the breaking sound and a predetermined threshold; and
indicating that the conduit is damaged when the relation of magnitude satisfies a predetermined condition, wherein the predetermined condition is associated with the relation of magnitude.

2. The device according to claim 1, wherein the indicating further comprises:
indicating that the conduit is damaged based at least on color, light, or a shape.

3. A device for detecting damage to a conduit buried in ground, the device comprising a processor configured to execute a method comprising:
detecting a breaking sound at time of conduit damage;
determining a relation of magnitude between a characteristic value of the breaking sound and a threshold; and
notifying that the conduit is damaged when the relation of magnitude satisfies a predetermined condition.

4. The device according to claim 3, wherein the notifying further comprises monitoring the conduit, and when the predetermined condition is satisfied, notifying that the conduit is damaged.

5. The device according to claim 3, wherein the notifying further comprises:
producing bending loss in an optical fiber when the predetermined condition is satisfied; and
determining the bending loss and a point of occurrence of the bending loss.

6. The device according to claim 1, wherein the detecting of the breaking sound uses a microphone or an optical fiber.

7. A computer implemented method for detecting a damage to a conduit buried in ground, comprising:
detecting a breaking sound at time of conduit damage;
determining a relation of magnitude between a characteristic value of the breaking sound and a threshold; and
indicating that the conduit is damaged when the relation of magnitude satisfies a predetermined condition.

8. (canceled)

9. The device according to claim 1, wherein the detecting the breaking sound uses a plurality of microphones placed at respective conduit installation portions in a working space.

10. The device according to claim 1, wherein the characteristic value of the breaking sound is based on a volume of the breaking sound of the conduit.

11. The device according to claim 1, wherein the indicating includes ejecting in a working space a paint of a predetermined color associated with the damage to the conduit.

12. The device according to claim 1, wherein the indicating includes blowing a balloon in a working space to indicate the damage to the conduit.

13. The device according to claim 1, wherein the detecting the breaking sound uses a plurality of microphones placed at respective conduit installation portions in a working space.

14. The device according to claim 3, wherein the detecting the breaking sound uses a plurality of microphones placed at respective conduit installation portions in a working space.

15. The device according to claim 3, wherein the characteristic value of the breaking sound is based on a volume of the breaking sound.

16. The device according to claim 5, wherein the producing bending loss of the optical fiber including displacing a pulley attached to the optical fiber to bend the optical fiber.

17. The computer implemented method according to claim 7, wherein the indicating includes ejecting in a working space a paint of a predetermined color associated with the damage to the conduit.

18. The computer implemented method according to claim 7, wherein the indicating includes blowing a balloon in a working space to indicate the damage to the conduit.

19. The computer implemented method according to claim 7, wherein the detecting the breaking sound uses a plurality of microphones placed at respective conduit installation portions in a working space.

20. The computer implemented method according to claim 7, wherein the indicating further comprises:
indicating that the conduit is damaged based at least on color, light, or a shape.

21. The computer implemented method according to claim 7, wherein the detecting of the breaking sound uses a microphone or an optical fiber.
